(19) United States
(12) Patent Application Publication
(10) Pub. No.: US 2006/0002325 A1
(43) Pub. Date: Jan. 5, 2006

(54) Method for controlling conversion of vocoder mode in a mobile communication system

(75) Inventor: Yong Chang, Seongnam-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO REPUBLIC OF KOREA (KR)

(21) Appl. No.: 10/527,344

(22) PCT Filed: Jul. 12, 2004
(86) PCT No.: PCT/KR04/01723

§ 371 Date: Mar. 10, 2005

(30) Foreign Application Priority Data
Jul. 20, 2003 (KR) 10-2003-0047622

(51) Int. Cl. H04Q 7/00

(52) U.S. Cl. 370/328

(57) ABSTRACT

A method for controlling a mode of digital voice signals in a mobile communication system including a media mutual conversion between analog voice signals and the digital voice signals encoded according to one of a plurality of modes, and a base station controller for exchanging the encoded digital voice signals with the media gateway. If it is necessary to change a mode of voice signals based on a predetermined criterion during transmission of voice data, the base station controller transmits a mode change control request signal to the media gateway. The media gateway analyzes the requested mode, determines whether to change a mode of encoded digital voice signals, generates a response message, and transmits the response message gateway changes a mode of the transcoder at a predetermined time according to the determined mode.

### FIELD OF THE INVENTION

The present invention relates to an apparatus and a method for transmitting data in a mobile communication system, and more particularly to an apparatus and a method for controlling conversion of a vocoder mode in a mobile communication system in order to change a transmission rate, when transmitting voice data.

### DESCRIPTION OF THE RELATED ART

Recently, with the rapid increase of the number of mobile communication subscribers, mobile communication services cooperate with Internet services, so that mobile stations have been developed to receive various types of data services, such as Internet services and multimedia services. Such a mobile communication system, that is, a code division multiple access mobile communication system (CDMA 2000 1×) will be described below with reference to an accompanying drawing.

FIG. 1 is a block diagram illustrating a structure of a conventional CDMA 2000 1× system.

As shown in FIG. 1, the CDMA 2000 1× includes a mobile switching center (MSC) 30 and a packet data service node (PDSN) 40, in which the mobile switching center 30 switches voice and data transmitted/received from/to a mobile station to a relevant destination in cooperation with a base station 20 and in which the packet data service node 40 has a function of an interface to the Internet. In addition, the CDMA 2000 1× includes an interworking function (IWTF) 50 and a packet control function (PCF) 60, in which the interworking function 50 converts circuit data and packet data into each other and transmits the converted data when the interworking function 50 receives a data transmission request from the mobile switching center 30, and in which the packet control function 60 is connected between the packet data service node 40 and the base station 20 to interface voice signals and data.

The base station 20 includes base transceiver stations (BTSs) 22a and 22b and a base station controller (BSC) 21 for controlling the base transceiver stations (BTSs) 22a and 22b.

An A1 interface and user information A2/A5 interfaces used for only circuit data are established between the mobile switching center 30 and the base station controller 21. Also, an A3 interface is provided in order to simultaneously transmit/receive a control signal and user data when selection of a reverse frame and transmission of a forward frame are conducted between the base station controller and another base station during soft handoff of a mobile station. The base station controller 21 includes a transcoder (or a vocoder) 23.

The transcoder (or vocoder) 23 has a role of converting a wireless vocoder frame into a PCM vocoder frame, which is not a wireless vocoder but a representative wire vocoder, so as to transmit the wireless vocoder (e.g., EVRC, SMV, or Q-CELP) frame, which is transmitted from a mobile station through a radio section, to a wire concentrating network after the base station controller 21 has received the wireless vocoder frame. Since the conventional transmission line between a base station controller and a mobile switching center is a TDM transmission line, a frame created by a wireless vocoder of a mobile station cannot be transmitted between them. That is, a frame created in a wireless vocoder having a usable band less than 13 kbps is transmitted into a frame created in the transcoder of the base station controller by using all band of 64 kbps.

Accordingly, it is difficult to obtain a higher transmission rate through the TDM transmission line formed between the base station and the mobile switching center, increasing the cost for the TDM transmission line. Therefore, it is necessary to move the transcoder or vocoder of the base station controller to a place adjacent to the mobile switching center and to exchange the TDM transmission line formed between the base station and the mobile switching center with a packet transmission line.

### SUMMARY OF THE INVENTION

Therefore, the present invention has been made in view of the above-mentioned problems, and it is an object of the present invention to provide an apparatus and a method for processing a voice data frame when transmitting/receiving voice information between a packet switch and a base station controller in a next generation mobile communication system including a circuit network and an additional circuit network, suitable for a packet-based IP network.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a block diagram illustrating a structure of a conventional CDMA 2000 1× system;

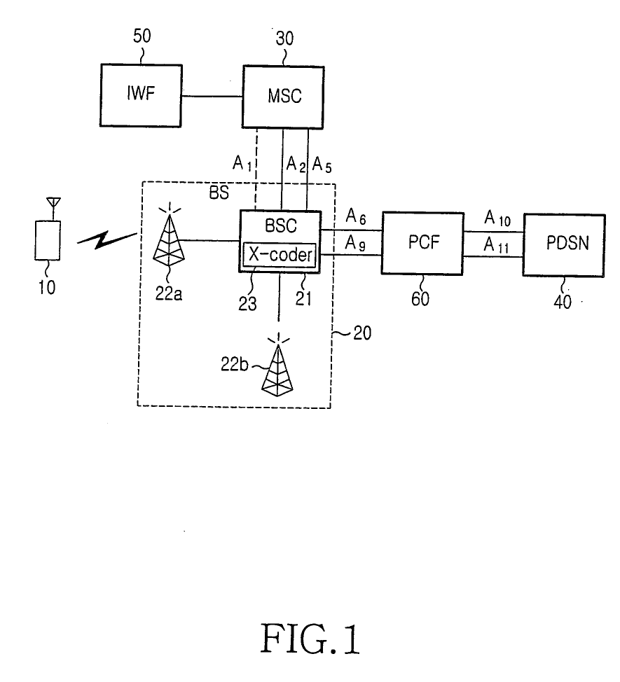

FIG. 2 is a block diagram illustrating a structure of a CDMA 2000 1× system according to an embodiment of the present invention;

FIG. 3 is a view illustrating a protocol stack of a CDMA 2000 1× system according to an embodiment of the present invention;

FIG. 4A is a flowchart illustrating a call processing procedure for controlling a mode of an SMV as a part of a method for controlling conversion of a vocoder mode between a BSC and an MGW according to an embodiment of the present invention;

FIG. 4B is a flowchart illustrating a mode control determination procedure for an SMV as a part of a method for controlling conversion of a vocoder mode in a base station;

FIG. 5 is a flowchart illustrating a failure of vocoder mode conversion between a base station controller and a media gateway according to an embodiment of the present invention;

FIG. 6 is a view illustrating an A2p reverse frame message of a frame protocol when an in-band signaling scheme is used;

FIG. 7 is a view illustrating an A2p forward frame message of a frame protocol when an in-band signaling scheme is used;

FIG. 8 is a view showing elements of frame protocol control procedure information included in frame protocols shown in FIGS. 6 and 7;

FIG. 9 is a view showing elements of mode control information included in frame protocols shown in FIGS. 6 and 7;

FIG. 10 is a view showing elements of reverse layer-3 data information of a frame protocol shown in FIG. 6;

FIG. 11 is a view showing elements of forward layer-3 data information of a frame protocol shown in FIG. 7;

FIG. 12 is a view showing information elements related to a message error check (Message CRC) applied to a message type and forward layer-3 data;

FIG. 13 is a view showing elements of Cause information;

FIG. 14 is a view showing an Amp SMV mode control (or vocoder rate change) message when an out-of-band signaling scheme is used for a mode control; and

FIG. 15 is a view showing an Amp SMV mode control (or vocoder rate change) Ack message when an out-of-band signaling scheme is used for a mode control.

### DETAILED DESCRIPTION OF THE PREFERRED EMBODIMENT

Reference will now be made in detail to the preferred embodiments of the present invention. In the following description of the present invention, a detailed description of known functions and configurations incorporated herein will be omitted when it may make the subject matter of the present invention unclear.

According to a mobile communication system of the present invention, a mobile switching center (MSC) is divided into an MSC emulator (MSCe or media gateway control (MGC)) and a media gateway (MGW), in which the MSC emulator takes charge of a call control and a mobility control. The media gateway takes charge of converting voice data from an analog signal to a digital signal (or vice versa) and has a role of forwarding the converted data. Therefore, a conventional bearer interface for transmitting voice information between a mobile switching center and a base station controller corresponds to an interface between the media gateway and a base station controller in the present invention. In addition, a frame protocol capable of checking packet arrival sequence and a transmission state between the media gateway and the base station controller is newly established in such a manner that voice information is received in or transmitted from a mobile station. Also, the mobile communication system of the present invention is an LMSD (Legacy MS Domain) system of a CDMA (Code Division Multiple Access) 2000 1×, and is represented through a network reference model between a radio access network (RAN) and a core network (CN). Such a next generation mobile communication system (CDMA 200 1×) will be described in detail with reference to the accompanying drawings.

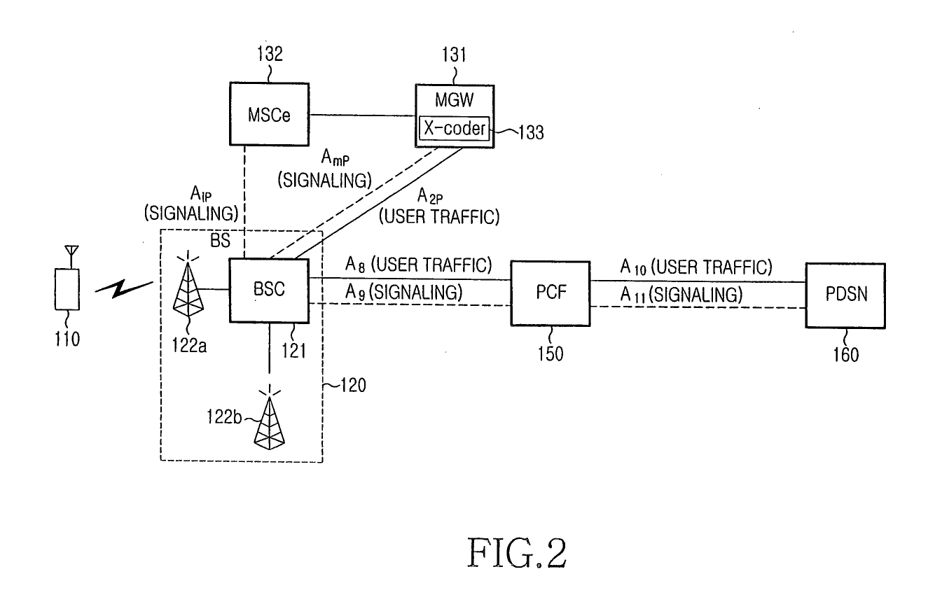

FIG. 2 is a block diagram illustrating a structure of a CDMA 2000 1× system according to an embodiment of the present invention.

As shown in FIG. 2, the CDMA 2000 1× system includes a base station controller 121, a media gateway 131, an MSC emulator 132, a packet data service node (PDSN) 160, and a pack-et control function (PCF) 150.

The media gateway 131 cooperates with the base station controller 121, and includes a transcoder 133 for converting an analog voice signal into a digital signal or vice versa. The transcoder 133 is called a “vocoder”. The transcoder 133 performs a forward operation to convert a voice data frame transmitted from a, general wire telephone into a wireless vocoder frame used in a wireless mobile station by using a pulse code modulation (PCM) scheme. Also, the transcoder 133 performs a reverse operation to convert voice data generated by the wireless, vocoder of the wireless mobile station into PCM voice data of 64 kbps by using a pulse code modulation (PCM) scheme. The vocoder used for the CDMA 2000 1× has a variable transmission rate. That is, the transcoder 133 performs a coding operation at a reduced transmission rate when there is a little voice signal, and the transcoder 133 performs a coding operation at a maximum transfer rate when there is a large amount of voice signals.

The MSC emulator 132 exchanges a call control signal, a mobility control signal, and a media gateway control signal with each other.

The packet control function 150 cooperates with the packet data service node 160 connected to an Internet in order to control and manage handoffs, and to manage packet data service profiles of mobile stations.

The MSC emulator 132 or the media gateway 131 is connected to the base station controller 121 through “A1p”, “A2p” and “AMP” interfaces. A signaling is transmitted through the AMP interface and a user traffic is transmitted through the A2p interface.

A signal, which is conventionally transmitted through an A1 interface between the base station controller and the MSC, is transmitted through the Alp interface and a signal, which is conventionally transmitted through an A2, is transmitted through the A2p interface. In addition, the Amp interface established between the base station controller 121 and the media gateway 131 performs an out-of-band signaling for the purpose of establishing, maintaining, and managing a bearer. The functions defined for the Amp interface may be performed by an in-band signaling in the frame protocol of the A2p interface. Such the A1p, A2p, and Amp interfaces are not normal circuit-based interfaces but packet-based (ATM or IP) interfaces.

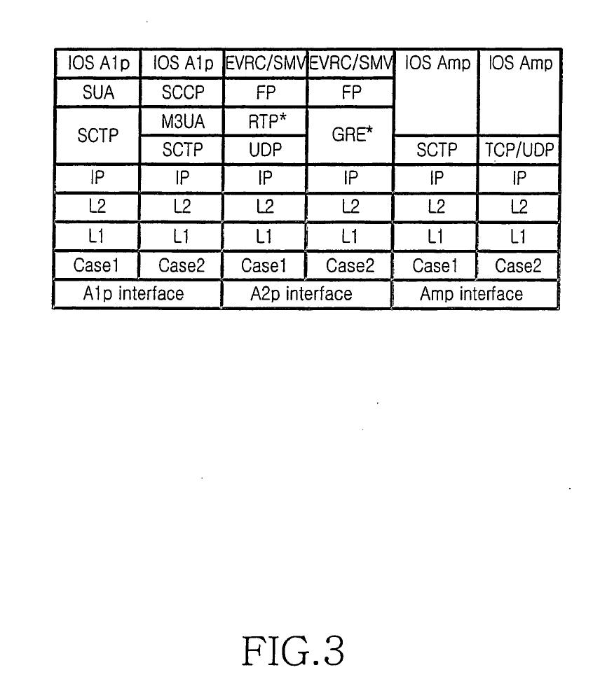

An example of a protocol stack which is defined in an interface between the base station controller 121 and the media gateway 131 will be described below with reference to FIG. 3.

In the following description for the protocol stack shown in FIG. 3, only “Case 1” applied to the present invention will be described, without describing “Case 2”.

In the protocol stack of the A2p interface, RTP* (Real time Transport Protocol*) and GRE* (Generic Route Encapsulation*) have functions slightly modified from those of the conventional. RTP and GRE, respectively. This means that it is not required for the RTP* and GRE* to have all functions of conventional RTP and GRE, such as a function of multiplexing data of multiple users with a single port.

The Amp interface is used for out-of-band signaling in a control process provided by the frame protocol, and is established as a separate interface. When, the Amp interface matches with the media gateway via the MSC emulator 132, an SCTP (Session Control Transmission Protocol) is used for the protocol stack.

The frame protocol defined in the above-mentioned protocol stack will be described below.

When voice information is transmitted between the media gateway and the base station controller, the frame protocol operating on the RTP or the GRE provides a procedure for processing a voice data frame and a control procedure thereof. Main functions of the frame protocol are as follows:

First, the frame protocol has a function of creating and transmitting a frame before voice data information has been transmitted, and a function of individually analyzing control information and voice data information included in a frame after receiving the frame.

Second, the frame protocol has an initialization function including a function of assigning quality of service (QoS) of a transmission line before voice data are transmitted between the base station controller and the media gateway and a function of assigning a frame number with respect to frames when transmitting or receiving the frames.

Third, the frame protocol has a function of establishing and maintaining synchronization during an actual signal transmission/reception process through reporting a signal delay in real time if the signal delay occurs while voice data information is being transmitted or received.

Fourth, the frame protocol has a function of controlling a vocoder transmission for converting a transmission rate and a transmission mode of a vocoder included in the media gateway in match with a converted transmission rate and a converted transmission mode of a vocoder used in a mobile station.

Fifth, the frame protocol has a function of controlling a transmission rate of voice data transmitted from the media gateway at a specific time so as to multiplex a signal message and a secondary traffic created in the base station through a DB (Dim and Burst) scheme or a BB (Blank and Burst) scheme, and to transmit the multiplexed data to a mobile station.

From among the above functions of the frame protocol, the present invention relates to the fourth function of the frame protocol used for controlling the transmission rate and the transmission mode of the vocoder included in the media gateway in match with the converted transmission rate and converted transmission mode of the mobile station. Thus, other functions will not be described below.

Hereinafter, the description will be made in relation to a method for controlling a mode of a selective mode vocoder (SMV) capable of selecting a transmission rate at a voice data transmission interval between a base station controller and a media gateway in a CDMA 2000 1×.

The SMV may have total six modes including four basic modes and two modified modes obtained by modifying the four basic modes.

The four basic modes of the SMV are determined according to Estimated Average Encoding Rate for active speed, wherein the SMV has four modes of 7.95 kbps (mode=000), 5,82 kbps (mode=001), 4.50 kbps (mode=010), and 3.95 kbps (mode=011). The above numeral values signify a bit number per second obtained when transmitting the voice frame, so quality of the voice frame may improve as the numeral values become higher. 7.96 kbps of mode=000 may ensure quality of the voice frame similar to quality of a voice frame with a full rate of a conventional EVRC 81 kbps vocoder.

Since Estimated Average Encoding Rate for active speed of the conventional EVRC 8 kbps vocoder is about 5 kbps on the average, higher quality of voice can be obtained at higher modes of the SMV as compared with that of the conventional EVRC 8 kbps vocoder. Two modified modes can be obtained by applying a half rate coding, to mode=000 and mode=001 and used for multiplexing a signal message with other traffics. The SMV has two modified modes of 4.0 kbps (mode=100) and 3.67 (mode=101), but they are rarely used.

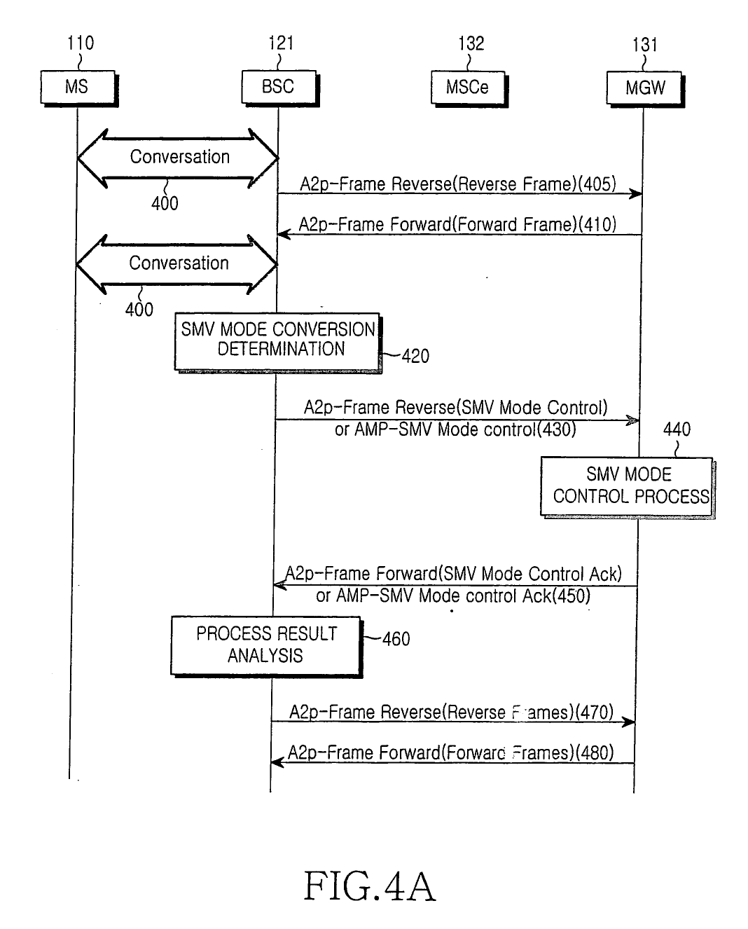

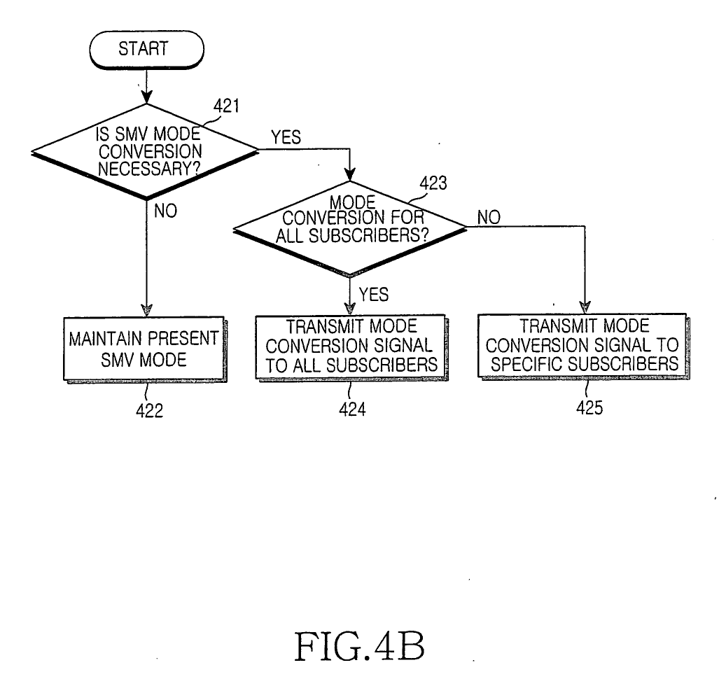

FIG. 4A is a flowchart illustrating a call processing procedure for controlling a mode of an SMV as a part of a method for controlling conversion of a vocoder mode between a BSC and an MGW according to an embodiment of the present invention.

In step 400, the mobile station (MS) 110 performs voice communication with a called party after establishing a session with a base station controller (BSC) 121.

Then, the BSC 121 transmits a voice data frame received from the MS 110 to a media gateway (MGW) 131 by adding the voice data frame to an A2p reverse frame message together with a voice data transmission rate and information bits (step 405). In addition, the MGW 131 transmits a voice data frame received from an MGW of the called party to the BSC 121 by adding the voice data frame to an A2p forwarding frame message together with a voice data transmission rate and information bits (step 410).

While the MS 110 is performing a voice call with the called party, conversion of the SMV mode may occur. In this case, service option negotiation is performed between the MS 110 and the BSC 121.

The SMV mode is converted when the BSC 121 or the MS 110 determines the conversion of the SMV mode based on a predetermined criterion.

Also, the conversion of the SMV mode may occur when a mode provided from a target BSC is different from a mode provided from a previous BSC during a hard handoff. Steps 420 to 460 shown in FIG. 4A represent a procedure for controlling the conversion of the SMV mode. The purpose of steps 420 to 460 is to notify the MWG 131 of the conversion of the SMV mode when the BSC 121 requests the conversion of the SMV during a voice call. The mode control procedure is performed by the BSC 121, which actually controls a mode. Although the mode control procedure is carried out in the BSC 121 in order to increase the number of subscribers using voice services and to improve voice quality, this can be varied depending on a management scheme of service providers. Also, mode values adjusted by the BSC 121 include values of all data transmission rates of an SMV frame of actual users. A main procedure will-begin anytime if transmission of an actual SMV frame is not interrupted by other control procedures.

As described above, the BSC 121 determines the conversion of an SMV mode of the MS 110 in step 420. The conversion of the SMV mode is determined according to a criterion prepared by service providers. For example, the criterion may include performance according to time zones, the number of subscribers, quality of voice service, etc. Step 420 will be described later in detail with reference to FIG. 4b.

If the conversion of the SMC mode is determined in step 420, the BSC 121 transmits a control message, which is a mode conversion request signal, through an in-band signaling scheme or an out-of-band signaling scheme in step 430.

According to the in-band signaling scheme, the control message is transmitted by means of a transmission frame of a frame protocol. In addition, according to the out-of-band signaling scheme, voice data and the control message are transmitted through a separate signaling interface (AMP) as independent signals.

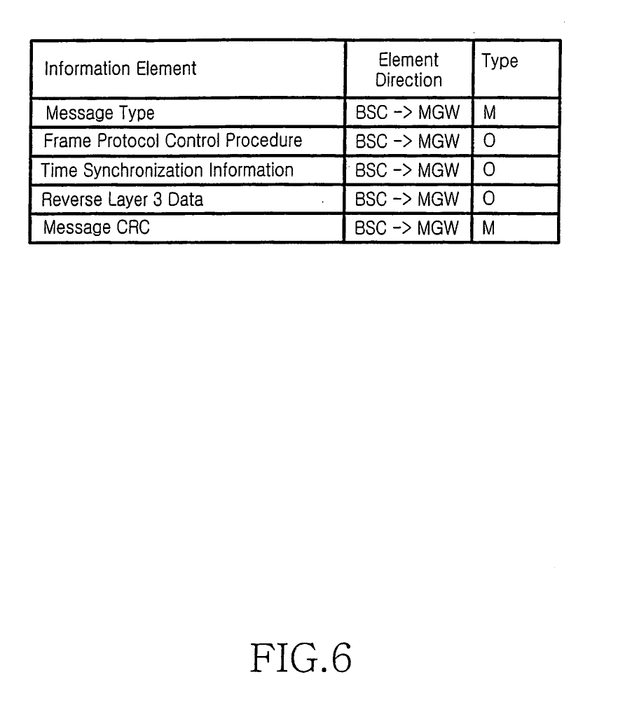

In a case of the in-band signaling scheme, in step 430, the BSC 121 transmits an SMV mode control signal to the MGW 131 by assigning the SMV mode control signal in an A2p reverse frame in order to request the conversion of the SMV mode as shown in FIG. 6 which will be described later in detail.

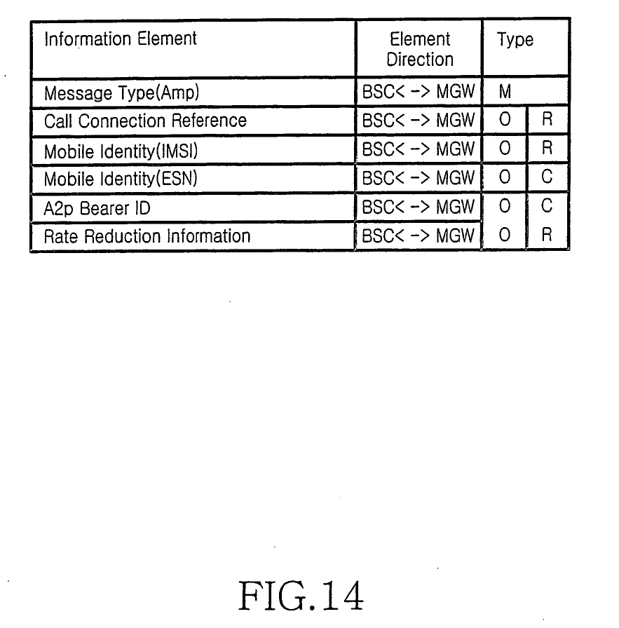

In a case of the out-of-band signaling scheme, in step 430, the BSC 121 transmits an SMV mode control signal to the MGW 131 by assigning the SMV mode control signal in an Amp-SMV mode control message in order to request the conversion of the SMV mode as shown in FIG. 14 which will be described later in detail.

At this time, the BSC 121 operates a timer TMC in order to measure an action time. Then, if the BSC 121 receives an ACK frame, which is a message representing a receipt of a signal, an operation of the timer is stopped.

In step 440, after-receiving the SMV mode control frame from the BSC 121, the MGW 131 checks an identity of the SMV mode control frame. To this end, the MGW 131 checks a CRC of the SMV mode control frame received therein. If the CRC has no problem, that is, if the identity of the SMV mode control frame matches with predetermined mode control information, the MGW 131 controls the SMV mode of the MS 110.

In step 450, the MGW 131 prepares an acknowledgement frame as authentication for the mode control frame including an authentication result for the mode conversion and transmits the acknowledgement frame to the BSC 121. The acknowledgement frame can be transmitted to the BSC 121 through the in-band signaling scheme or the out-of-band signaling scheme.

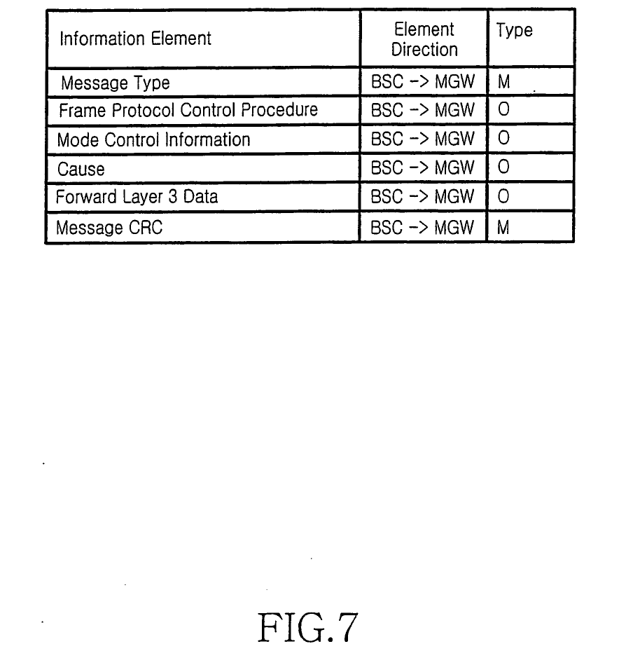

In a case of the in-band signaling scheme, in step 450, the MGW 131 transmits an SMV mode ACK signal to the BSC 121 by assigning the SMV mode ACK signal in an A2p forward frame as shown in FIG. 7 which will be described later in detail.

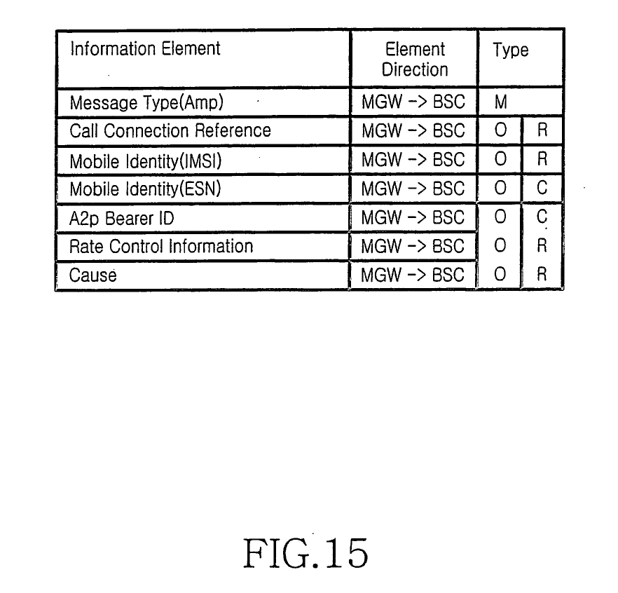

In a case of the out-of-band signaling scheme, in step 450, the MGW 131 transmits an SMV mode ACK signal to the BSC 121 by assigning the SMV mode ACK signal in an Amp-S MV mode control ACK message as shown in FIG. 15 which will be described later in detail.

In step 460, the BSC 121 receives the SMV mode control ACK message from the MGW 131 and analyzes a processing result of the MGW 131 with respect to the control procedure previously requested by the BSC 121. The procedure returns to step 430 or goes to step 470 according to the above analysis.

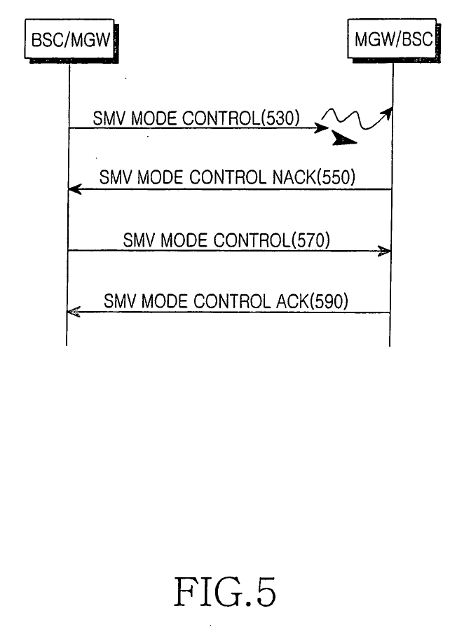

First, a control procedure of the BSC 131 when the procedure returns to step 430 will be described in detail with reference to FIG. 5.

As shown in FIG. 5, the procedure returns to step 430 if the mode control frame transmitted in step 530 is broken or has an error. In this case, the MGW transmits a mode control NEGATIVE ACKNOWLEDGEMENT to the BSC 121 (step 550) regardless of the mode control frame received in the MGW 131 based on the CRC result.

Such an error of the mode control frame may occur when the mode control frame does not reach the MGW 131 or when the mode information transmitted through the mode control frame is not available.

Due to the error of the mode control frame, the frame protocol retries the mode control procedure if the BSC 121 receives a mode control NACK signal, or if the BSC 121 does not receive any mode control ACK signals in step 450 before the timer TMC set at a transmission time of the mode control signal has been finished. That is, as shown in FIG. 5, the BSC 121 retries step 570. If the error of the mode control frame continuously occurs even if the BSC 121 retries step 570 by NMC times, an additional relevant treatment must be carried out.

If the SMV mode conversion procedure has been completed between the BSC 121 and the MGW 131 through steps 420 to 460, the BSC 121 and the MGW 131 are operated with a converted SMV mode for a predetermined action time. That is, in step 470, the BSC 121 transmits the voice data frame, which is transmitted to the BSC 121 from the MS 110, to the MGW 131 for the action time with the converted SMV mode by adding the voice data frame to the A2p reverse frame together with the voice data transmission rate and information bits.

In step 480, the MGW 131 transmits the voice data frame, which is transmitted to the MGW 131 from the MS of the called party, to the BSC 121 for the action time with the converted SMV mode by adding the voice data frame to the A2p forward frame together with the voice data transmission rate and information bits.

Hereinafter, the substeps of step 420 will be described with reference to FIG. 4B. FIG. 4B is a flowchart illustrating a procedure for determining the conversion of an SMV in the base station.

In step 421, the BSC 121 determines whether or not it is necessary to convert the SMV mode based on a predetermined criterion. As mentioned above, the predetermined criterion includes a number of subscribers trying call connection in each time zone, a call connection rate, a power control status of the BSC, and a mean number of handoff operations of the MS caused by a movement of the MS to an area in which speech quality of the MS becomes lowered.

If it is determined that the conversion of the SMV mode is not necessary in step 421, a present SMV mode is continuously maintained (step 422). In this case, it is not necessary to carry out steps 430 to 460 shown in FIG. 4A.

In contrast, if it is determined that the conversion of the SMV mode is necessary in step 421, the BSC 121 determines whether the conversion of the SMV mode must be performed for all subscribers or for specific subscribers (step 423). In this case, it is not necessary to carry out steps 430 to 460 shown in FIG. 4A.

If it is determined that the conversion of the SMV mode must be performed for all subscribers in step 423, the BSC 121 transmits a signal requesting a mode conversion to all BSCs through the MSCe 132 in order to perform the mode conversion with respect to all subscribers (step 424). A signal flow of step 423 is not illustrated in FIG. 4.

In addition, if it is determined that the conversion of the SMV mode must be performed for specific subscribers in step 423, the BSC 121 transmits a signal requesting a mode conversion to specific BSCs in order to perform the mode conversion with respect to the specific subscribers (step 425).

Hereinafter, messages for the above SMV mode conversion will be described in detail with reference to FIGS. 6 to 15.

FIG. 6 is a view illustrating an A2p reverse frame message of a frame protocol used for the conversion of a vocoder mode to control a transmission rate when an in-band signaling scheme is used. In FIG. 6, options required only for the A2p reverse frame message of the frame protocol to control the conversion of the vocoder mode are illustrated.

Referring to FIG. 6, the A2p reverse frame message is transmitted from the BSC 121 to the MGW 131 and essentially includes information related to a message type and a message CRC. In addition, the A2p reverse frame message can selectively include a frame protocol control procedure, mode control information and reverse layer-3 data.

FIG. 7 is a view illustrating an A2p forward frame message of the frame protocol when the in-band signaling scheme is used. In FIG. 7, options required only for the A2p forward frame message of the frame protocol to control the conversion of the vocoder mode are illustrated.

Referring to FIG. 7, the A2p forward frame message is transmitted to the BSC 121 from the MGW 131 and essentially includes information related to a message type and a message CRC. In addition, the A2p forward frame message can selectively include a frame protocol control procedure, cause information, mode control information, and forward layer-3 data.

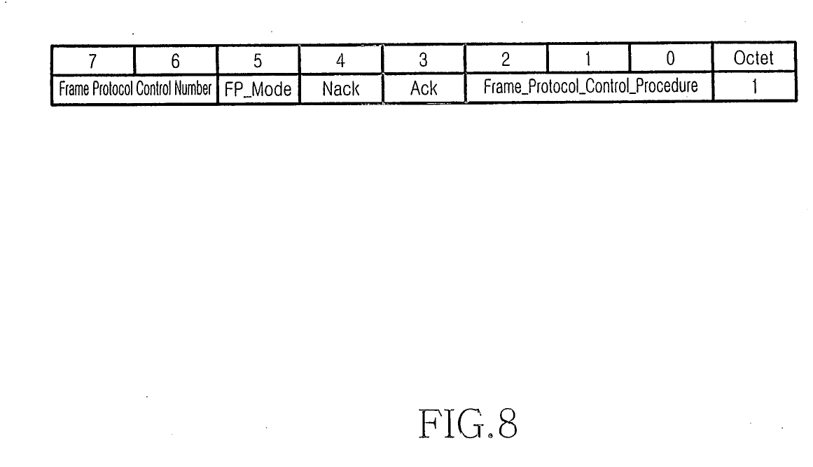

FIG. 8 is a view showing elements of frame protocol control procedure information included in frame protocols shown in FIGS. 6 and 7.

Referring to FIG. 8, Frame Protocol Control Number is a number of a frame in which a frame protocol control type is assigned (control operation).

FP_Mode represents a frame protocol mode. If the FP_Mode is “0”, a transparent mode is enabled. If the FP_Mode is “1”, a non-transparent mode is enabled. In a case of the transparent mode, the message of the frame protocol is instantly transmitted without being processed. In a case of the non-transparent mode, the message of the frame protocol is transmitted after the frame protocol has been processed. The transparent mode is available when the MGW has a role of a multimedia MGW. This is because the frame protocol of the present invention is not applied to a message if the message is transferred to an RAN from the MGW of a VoIP call controlled by an SIP call on an IP layer. Selection of the transparent mode or the non-transparent mode depends on a MEGACO (media gateway control) message transmitted from an MSC server or an MGCF (media gateway control function).

Ack/Nack represents values of Ack and Nack for a message determined in a frame protocol control type.

Frame_Protocol_Control_Procedure represents a control status for the frame protocol included in a transmitted message. Values of the Frame_Protocol_Control_Procedure are shown in Table 1.

TABLE 1

| Frame_Protocol_Contro_Procedure value | Meaning |
|---|---|
| 000 | Initialization |
| 001 | Time Synchronization |
| 010 | Rate Control |
| 011 | Mode Control |
| 000-111 | Reserved |

As shown in Table 1, information elements, such as initialization information, time synchronization information, rate control information, mode control information and the like, are selectively added into A2p FP forward and reverse messages according to values of the Frame_Protocol_Control-Procedure.

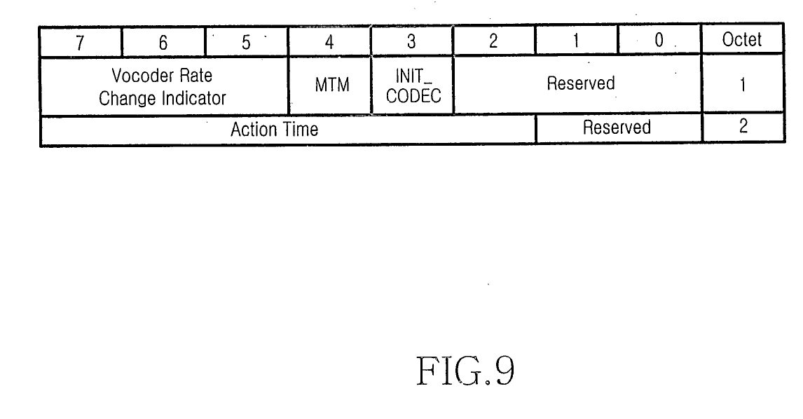

FIG. 9 is a view showing elements of mode control information included in frame protocols shown in FIGS. 6 and 7.

Referring to FIG. 9, Vocoder Rate Change Indicator represents a rate of a mode operation when controlling the SMV mode and the transmission rate. Values of the Vocoder Rate Change Indicator are shown in Table 2.

TABLE 2

| | Meaning | |
|---|---|---|
| Vocoder Rate | | Estimated Average |
| Change | | Encoding Rate for |
| Indicator Value | SMV Encoding Mode Operation | active speech (Kbps) |
| 000 | 0 | 7.95 |
| 001 | 1 | 5.82 |
| 010 | 2 | 4.50 |
| 011 | 3 | 3.95 |
| 100 | 4(½ rate Maximum applied | 4.0 |
| | Mode 0) | |
| 101 | 5(½ rate Maximum applied | 3.67 |
| | Mode 1) | |
| 110-111 | Reserved | Reserved |

MTM represents a mobile-to-mobile processing.

INIT_CODEC is an Initialize Speech Codec. If a value of the INIT_CODEC is “1”, the SMV of the MGW is initialized. If it is unnecessary to initialize the SMV, the INIT_CODEC is set to “0”. Action time signifies a system time required for converting a mode of the SMV into a predetermined mode- or for initializing the SMV.

In Table 2, if an EVRC vocoder is used instead of the SMV, information fields of the elements forming the mode control information are as follows:

Vocoder Rate Change Indicator represents a rate reduction of the EVRC. Values of the Vocoder Rate Change Indicator are shown in Table 3.

TABLE 3

| Vocoder Rate | Meaning | |
|---|---|---|
| Change | Fraction of Normally Rate | Fraction of Normally Rate |
| Indicator value | 1 Packets to be Rate 1 | 1 Packets to be Rate ½ |
| 000 | 0 | 0 |
| 001 | ¾ | ¼ |
| 010 | ½ | ½ |
| 011 | ¼ | ¾ |
| 100 | 0 | 1 |
| 110-111 | Reserved | Reserved |

MTM represents a mobile-to-mobile processing.

INIT_CODEC is an Initialize Speech Codec. If a value of the INIT_CODEC is “1”, the EVRC vocoder of the MGW is initialized. If it is unnecessary to initialize the EVRC vocoder, the INIT_CODEC is set to “0”. Action time signifies a system time required for converting a mode of the EVRC vocoder into a predetermined mode or for initializing the EVRC vocoder.

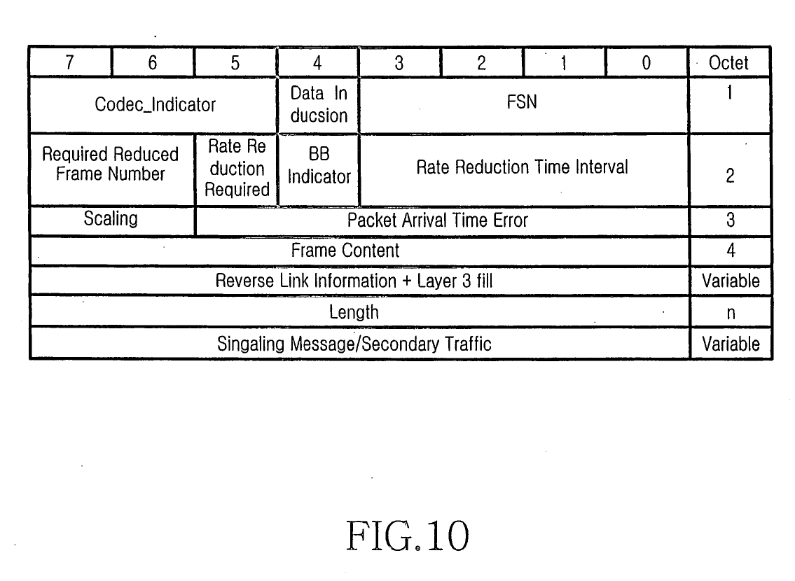

FIG. 10 is a view showing elements of reverse layer-3 data information of a frame protocol shown in FIG. 6.

Referring to FIG. 10, Codec Indicator represents information related to a codec which is currently used. As shown in Table 4 below, a codec indicator value of “000” represents a codec of an EVRC (Enhanced Variable Rate Coding) scheme, a codec indicator value of “001” represents a codec of an SMV coding scheme, a codec indicator value of “010” represents a codec of a 13K Q-CELP (Qualcom Code Excited Linear Prediction) coding scheme, and a codec indicator value of “100” represents a codec of an AMR (Adaptive Multi-Rate) coding scheme. Remaining codec indicator values of “101” to “111” are reserved values.

TABLE 4

| Codec Indicator value | Meaning |
|---|---|
| 000 | EVRC |
| 001 | SMV |
| 010 | 13K Q-CELP |
| 011 | 8K Q-CELP |
| 100 | AMR |
| 101˜111 | Reserved |

Frame Sequence Number (FSN) represents information appointed by a value obtained through performing a modulo-operation with sixteen for a value representing system time according to frames by the base station controller. The value obtained through the modulo-operation may represent a point of time at which the base station controller receives a frame backwardly from the base transceiver station.

Required Reduced Frame Number represents information related to the number of 20 ms frames required to be reduced for reducing a transmission rate when a signaling message to be transmitted from the base station controller must be multiplexed through multiple 20 ms frames to be transmitted. That is, it may be necessary to reduce as many forward frames as the value of the Required Reduced Frame Number, which is shown in Table 5.

TABLE 5

| Required Reduced Frame Number Value | Meaning |
|---|---|
| 00 | One 20 ms frame |
| 01 | Two 20 ms frames |
| 10 | Three 20 ms frames |
| 11 | Four 20 ms frames |

“Rate Reduction Required” is a field of indicating that a signaling message to be transmitted from the base station controller is in a rate reduction time interval. If there is a signaling message to be transmitted, the value of “Rate Reduction Required” is set as “1”, and if not, the value is set as “0”.

“BB Indicator” is a Blank and Bust indicator. If the base station controller requires a BB scheme so as to transmit a signaling message or supplementary data, the value of “BB indicator” is set as “1”, and if not, the value is set as “0” which indicates the Dim and Burst scheme.

“Data Inclusion” is a field of indicating whether or not a signaling message or secondary traffic to be multiplexed and transmitted by the base station controller will be inserted into the current frame protocol reverse data to be transmitted. If a signaling message or supplementary data are inserted, the value of “Data Inclusion” is set as “1”, and if not, the value is set as “0”. When the value of “Data Inclusion” is set as “1”, a signaling message or supplementary data corresponding to a value set in a “Length” field are inserted.

“Rate Reduction Time Interval” is a field of indicating a time interval during which the base station controller desires to transmit a signaling message or secondary traffic. The values of the “Rate Reduction Time Interval” are in a range of values, which are set at intervals of 20 ms from a point of time set in the “FSN (Frame Sequence Number)” field. That is, the respective values of “Rate Reduction Time Interval” represent one of a range of “a value (decimal) of Rate Reduction Time Interval×20 ms”, and a range has a time interval of 320 ms from CDMA System Time represented in “FSN”.

“Scaling” represents a time scale set for values of a packet arrival time error (PATE) by the base station controller. The values of “Scaling” are shown in Table 6.

TABLE 6

| Scaling Field Value | Time Units | PATE Range |
|---|---|---|
| 00 | 0.125 ms | ±3.875 ms |
| 01 | 1.0 ms | ±31.0 ms |
| 10 | 1.25 ms | ±38.75 ms |
| 11 | 5.0 ms | ±155 ms |

The packet arrival time error (PATE) represents a difference between a reception time in which the media gateway actually receives FP-Forward Layer-3 Data (Frame Protocol-Forward Layer-3 Data) and an expected arrival time calculated by the “Scaling” field. Therefore, the ranges of the PATE are represented as positive or negative values and are established as shown in Table 6 according to values set in the “Scaling” field.

“Frame Content” is a field of indicating the number of information bits and a code symbol repetition rate, which are included in actual FP-forward layer-3 data information. Types of frames used for in-band signaling between the base station controller and the media gateway are shown in Table 7.

TABLE 7
Frame Content-Special Frame Content Parameters

| Frame | | | |
|---|---|---|---|
| Content | | Description | |
| (hex) | Name | Forward | Reverse |
| 00 | Idle' | Transmitted for frame | Transmitted for frame |
| | | synchronization between | synchronization |
| | | BSC and MGW before | between BSC and |
| | | establishment of | MGW before |
| | | wireless resource | establishment of |
| | | | wireless resource |
| 7C | Blank' | Transmitted when being | Transmitted when used |
| | | used in Blank and Burst | in Blank and Burst |
| 7D | Full Rate | Not Applicable | Radio Configuration 1, |
| | Likely | | Full Rate Likely |
| 7E | Erasure/ | Not Applicable | Insufficient Physical |
| | | | Layer Frame Quality |
| 7F | Null' | Used during DTX mode | Used during DTX |
| | | (When transmitting Null | mode (When there is |
| | | traffic frames to the MS) | only a pilot channel |
| | | | and no frames are |
| | | | being received on the |
| | | | traffic channel) |

1. The number of Information Bits for these frame content types is 0.

Frame Content—Frame Content Parameters

| Frame | | | Number of | Number of |
|---|---|---|---|---|
| Content | Radio | Data Rate | Layer 3 Fill | INformation |
| (hex) | Configuration | (bps) | Bits | Bits |
| 01 | Forward: 1 | 9600 | 4 | 172 |
| 02 | and Reverse: 1 | 4800 | 0 | 80 |
| 03 | | 2400 | 0 | 40 |
| 04 | | 1200 | 0 | 16 |
| 05 | Forward: 2 | 14400 | 4 | 268 |
| 06 | and Reverse: 2 | 7200 | 3 | 125 |
| 07 | | 3600 | 4 | 55 |
| 08 | | 1800 | 3 | 21 |
| 09 | Forward: 3, 4, 6, 7 | unused | — | — |
| 0A | and Reverse: 3, 5 | 9600(20 ms) | 4 | 172 |
| 0B | | 4800 | 0 | 80 |
| 0C | | 2700 | 0 | 40 |
| 0D | | 1500 | 0 | 16 |

Frame Content—Frame Content Parameters

| Frame | | | Number of | |
|---|---|---|---|---|
| Content | Radio | Data Rate | Layer 3 Fill | Number of |
| (hex) | Configuration | (bps) | Bits | INformation Bits |
| 0E | Forward: 5, 8, 9 | Unused | — | — |
| 0F | and Reverse: 4, 6 | 14400 | 5 | 267 |
| 10 | | 7200 | 3 | 125 |
| 11 | | 3600 | 1 | 55 |
| 12 | | 1800 | 3 | 21 |

“Length” contains information about a length of bytes included after the “Length” field. “Signaling message/Secondary Traffic” represents inserted signal message or supplementary data (secondary traffic) when the value of “Signaling message/Secondary Traffic” is set as “1”.

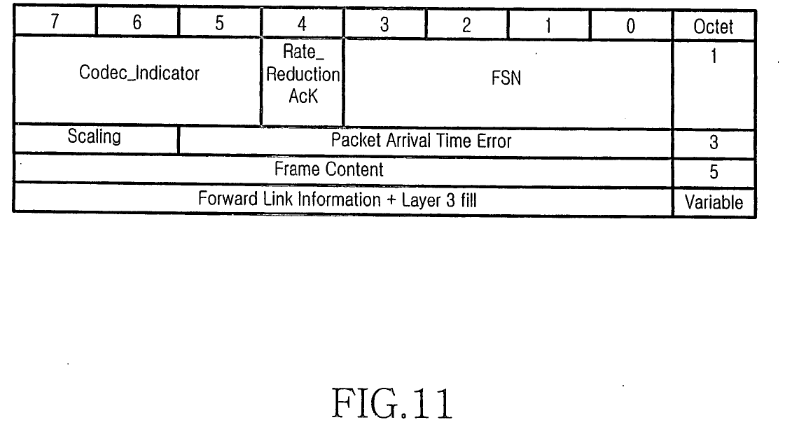

FIG. 11 is a view showing elements of forward layer-3 data information of a frame protocol shown in FIG. 7 and information fields thereof are as follows:

“Codec Indicator” is a field representing information related to a codec which is currently used. As shown in Table 8 below, a co dec indicator value of “000” represents a co dec of an EVRC (Enhanced Variable Rate Coding) scheme, a codec indicator value of “001” represents a codec of an SMV coding scheme, a codec indicator value of “010” represents a codec of a 13K Q-CELP (Qualcom Code Excited Linear Prediction) coding scheme, and a codec indicator value of “100” represents a codec of an AMR (Adaptive Multi-Rate) coding scheme. Remaining codec indicator values of “110” to “111” are reserved values.

TABLE 8

| Codec Indicator value | Meaning |
|---|---|
| 000 | EVRC |
| 001 | SMV |
| 010 | 13K Q-CELP |
| 011 | 8K Q-CELP |
| 100 | AMR |
| 101-111 | Reserved |

“Rate_Reduction_Ack” is set to “1” when the media gateway acknowledges a transmission-rate reduction request transmitted from the base station controller to use the DB (Dim and Burst) scheme, and reduces the transmission rate according to the transmission-rate reduction request. Otherwise, a basic value of the “Rate_Reduction_Ack” is set to “0”.

“Frame Sequence Number (FSN)” is a field appointing a value obtained through performing a modulo-operation with sixteen for a value representing system time according to frames by the media gateway. The value obtained through the modulo-operation may be used as a forward transmission time from the base station controller to the base transceiver station.

“Scaling” is a field in which the media gateway sets a time scale for values of a packet arrival time error (PATE). The values of “Scaling” are the same as those shown in Table 9.

TABLE 9

| Scaling Field Value | Time Units | PATE Range |
|---|---|---|
| 00 | 0.125 ms | ±3.875 ms |
| 01 | 1.0 ms | ±31.0 ms |
| 10 | 1.25 ms | ±38.75 ms |
| 11 | 5.0 ms | ±155 ms |

“Packet Arrival Time Error (PATE)” is a field of indicating a difference between a reception time in which the base station controller actually receives RP-Forward Layer-3 Data (Reverse Protocol-Forward Layer-3 Data) and an expected arrival time calculated by the “Scaling” field. Therefore, the ranges of the PATE are represented as positive and negative values, and are established as shown in Table 6 according to values set in the “Scaling” field. “Frame Content” is a field of indicating the number of information bits and a code symbol repetition rate. Types of frames used for in-band signaling between the base station controller and the media gateway are same as those shown in Table 10.

TABLE 10
Frame Content-Special Frame Content Parameters

| Frame | | | |
|---|---|---|---|
| Content | | Description | |
| (hex) | Name | Forward | Reverse |
| 00 | Idle' | Transmitted for frame | Transmitted for frame |
| | | synchronization between | synchronization |
| | | BSC and MGW before | between BSC and |
| | | establishment of | MGW before |
| | | wireless resource | establishment of |
| | | | wireless resource |
| 7C | Blank' | Transmitted when being | Transmitted when used |
| | | used in Blank and Burst | in Blank and Burst |
| 7D | Full Rate | Not Applicable | Radio Configuration 1, |
| | Likely | | Full Rate Likely |
| 7E | Erasure/ | Not Applicable | Insufficient Physical |
| | | | Layer Frame Quality |
| 7F | Null' | Used during DTX mode | Used during DTX |
| | | (When transmitting Null | mode (When there is |
| | | traffic frames to the MS) | only a pilot channel |
| | | | and no frames are |
| | | | being received on the |
| | | | traffic channel) |

1. The number of Information Bits for these frame content types is 0.

Frame Content—Frame Content Parameters

| Frame | | | Number of | Number of |
|---|---|---|---|---|
| Content | Radio | Data Rate | Layer 3 Fill | INformation |
| (hex) | Configuration | (bps) | Bits | Bits |
| 01 | Forward: 1 | 9600 | 4 | 172 |
| | and Reverse: 1 | | | |
| 02 | | 4800 | 0 | 80 |
| 03 | | 2400 | 0 | 40 |
| 04 | | 1200 | 0 | 16 |
| 05 | Forward: 2 | 14400 | 4 | 268 |
| | and Reverse: 2 | | | |
| 06 | | 7200 | 3 | 125 |
| 07 | | 3600 | 4 | 55 |
| 08 | | 1800 | 3 | 21 |
| 09 | Forward: 3, 4, 6, 7 | Unused | — | — |
| | and Reverse: 3, 5 | | | |
| 0A | | 9600(20 ms) | 4 | 172 |
| 0B | | 4800 | 0 | 80 |
| 0C | | 2700 | 0 | 40 |
| 0D | | 1500 | 0 | 16 |

Frame Radio Data Rate—Number of Number of

| Frame | | | Number of | |
|---|---|---|---|---|
| Content | Radio | Data Rate | Layer 3 Fill | Number of |
| (hex) | Configuration | (bps) | Bits | INformation Bits |
| 0E | Forward: 5, 8, 9 | Unused | — | — |
| | and Reverse: 4, 6 | | | |
| 0F | | 14400 | 5 | 267 |
| 10 | | 7200 | 3 | 125 |
| 11 | | 3600 | 1 | 55 |
| 12 | | 1800 | 3 | 21 |

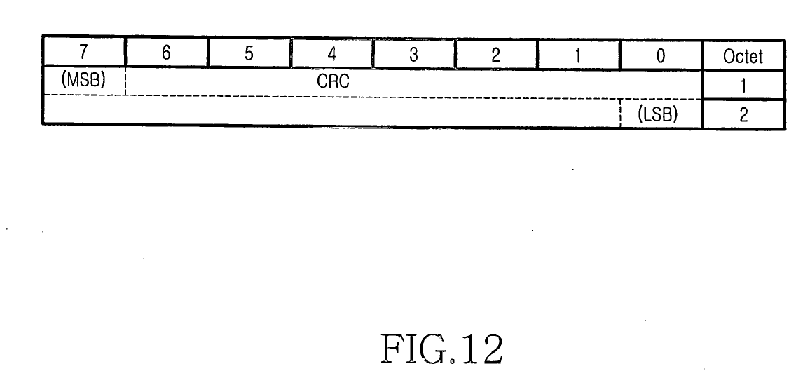

FIG. 12 is a view showing information elements related to a message error check (Message CRC) applied to a message type and forward layer-3 data.

The message error check is standard 16-bit information which is applied to forward layer-3 data and the message type, and checks a relevant message and a layer-3 data information element. For such a checking, a generator polynomial “g(x)=X¹⁶+X¹²+X⁵⁺¹” is used.

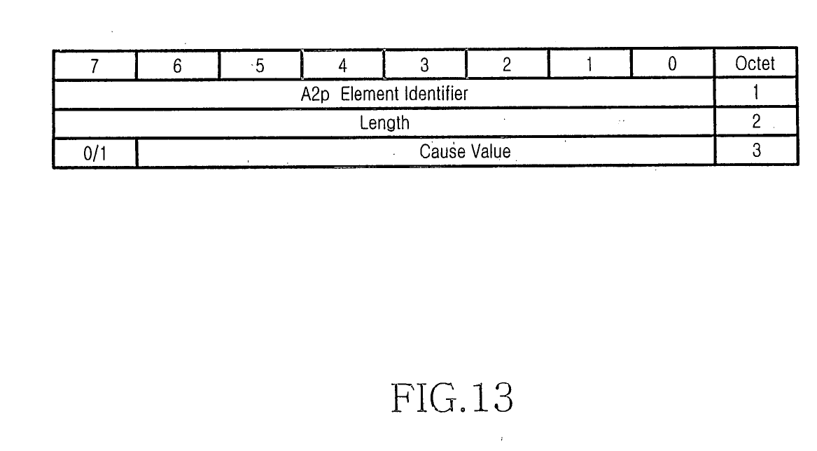

FIG. 13 is a view showing elements of Cause information. The class of Cause values between the base station controller and the media gateway is shown in Table 11.

TABLE 11

| Codec Indicator value | Meaning |
|---|---|
| 000 | Normal Event |
| 001 | Normal Event |
| 010 | Initialization is unavailable |
| 011 | Time Synchronization is unavailable |
| 100 | Rate Control is unavailable |
| 101 | Mode Control is unavailable |
| 000-111 | Reserved |

Detailed Cause values can be additionally determined later.

FIG. 14 is a view showing an Amp SMV mode control (or vocoder rate change) message when an out-of-band signaling scheme is used for a mode control. The message can be transmitted through an Amp frame and information elements forming the message are as follows:

Referring to FIG. 14, “Message type” is information representing an Amp SMV mode control (or vocoder rate change) message transmitted through an Amp interface of 1 byte. A number of the Amp SMV mode control (or vocoder rate change) message is assigned later.

TABLE 12

| | | | | | | | | |
|---|---|---|---|---|---|---|---|---|
| 7 | 6 | 5 | 4 | 3 | 2 | 1 | 0 | Octet |

| | |
|---|---|
| Amp Message Type | 1 |

“Call Connection Reference” is information representing a voice call connection number of a corresponding MS between the base station controller and the media gateway and fields thereof are shown in Table 13.

TABLE 13

| | | | | | | | | |
|---|---|---|---|---|---|---|---|---|
| 7 | 6 | 5 | 4 | 3 | 2 | 1 | 0 | Octet |

| Amp Element Identifier | | 1 |
|---|---|---|
| Length | | 2 |
| (MSB) | Market ID | 3 |

| | | |
|---|---|---|
| Market ID (continued) | (LSB) | 4 |

| | | |
|---|---|---|
| (MSB) | Generating Entity ID | 5 |

| Generating Entity ID (continued) | (LSB) | 6 |
|---|---|---|
| (MSB) | | 7 |
| Call Connection Reference Value | | 8 |
| | | 9 |
| | (LSB) | 10 |

Referring to Table 13, information about “Call Connection Reference” includes a “Length” field, a two-byte “Market ID” field which represents a market ID established by a service provider, a two-byte code number (Generating Entity ID) field which represents a code number assigned from a service provider to a device which generates a value of a call connection number, and a four-byte “Call Connection Reference Value” field which represents a value assigned by the “Generating Entity” to be used for discriminating whether or not a relevant mobile station transmits voice data.

“Mobile Identity” is information representing a number of a relevant mobile station, and includes a “Length” field and a “Type of Identity” field. Fields of the mobile identity are shown in Table 14.

TABLE 14

| | | | | | | | | |
|---|---|---|---|---|---|---|---|---|
| 7 | 6 | 5 | 4 | 3 | 2 | 1 | 0 | Octet |

| A9 Element Identifier | | | 1 |
|---|---|---|---|
| Length | | | 2 |
| Identity Digit 1 | Odd/even | Type of Identity | 3 |
| | Indicator | | |

| | | |
|---|---|---|
| Identity Digit 3 | Identity Digit 2 | 4 |
| | | . |
| | | . |
| | | . |
| Identity Digit N + 1 | Identity Digit N | 5 |

In Table 14, the “Length” field represents a byte length included after the “Length” field.

The “Type of Identity” field represents various kinds of MS identifiers as shown in Table 15.

TABLE 15

| Binary Values | Meaning |
|---|---|
| 000 | No Identity Code |
| 010 | Broadcast Address |
| 101 | ESN |
| 110 | IMSI |

“A2p bearer ID” represents information related to a bearer ID of the base station controller and the media gateway, which is used to transmit voice data between the base station controller and the media gateway, and indicates a port number of an RTP/UDP/IP or a GRE/IP of a transmitting party.

FIG. 15 is a view showing an Amp SMV mode control (or vocoder rate change) Ack message when an out-of-band signaling scheme is used for a mode control. Information elements forming the message is as follows:

Referring to FIG. 15, “Message type” signifies Amp Message Type 1 byte, and a number of the Amp SMV mode control (or vocoder rate change) Ack message is assigned later as represented in Table 16.

TABLE 16

| | | | | | | | | |
|---|---|---|---|---|---|---|---|---|
| 7 | 6 | 5 | 4 | 3 | 2 | 1 | 0 | Octet |

| | |
|---|---|
| Amp Message Type | 1 |

Cause information elements are identical to Cause information elements shown in FIG. 13. The Cause information elements are provided only when the Amp SMV mode control (or vocoder rate change) message is not accepted. Remaining information elements of the Amp SMV mode control (or vocoder rate change) Ack message are identical to those of the Amp SMV mode control (or vocoder rate change) message.

As can be seen from the foregoing, according to the apparatus and the method of the present invention, if the base station controller transmits the signal requesting the conversion of transmission rate and vocoder mode to the media gateway, the transcoder (or vocoder) installed in the media gateway converts the vocoder mode and the transmission rate and notifies the base station controller of the conversion of the vocoder mode and the transmission rate. Thus, it is possible to effectively transmit information related to the conversion of the voice vocoder mode and the transmission rate to the mobile station.

While this invention has been described in connection with what is presently considered to be the most practical and preferred embodiment, it is to be understood that the invention is not limited to the disclosed embodiment and the drawings, but, on the contrary, it is intended to cover various modifications and variations within the spirit and scope of the appended claims.

1. A method for controlling a mode of a coded voice signal in a base station transmitting/receiving the coded voice signal in a mobile communication system, the method comprising the steps of:
i) determining whether or not it is necessary to convert the mode of the voice signal based on a predetermined criterion;
ii) transmitting a mode conversion request message if it is necessary to convert the mode of the voice signal; and
iii) receiving a response signal representing a mode conversion state of the voice signal in response to the mode conversion request message.

2. The method according to claim 1, wherein the mode conversion request message or the response signal is transmitted through an A2p-frame with an in-band signaling scheme.

3. The method according to claim 1, wherein the mode conversion request message or the response signal is transmitted through an AMP-frame with an out-of-band signaling scheme.

4. The method according to claim 1, wherein the base station includes information related to a time for determining a mode conversion of the signal, which is previously determined.

5. The method according to claim 1, wherein, in step ii), if it is necessary to covert modes of signals for all subscribers, the base station transmits a signal requesting a mode conversion to other base station through a mobile switching center emulator connected to the base station.

6. The method according to claim 1, wherein a criterion for conducting a mode conversion of the signal includes a predetermined number of call connection tries of subscribers, a power control status of a corresponding base station, and a handoff of a mobile station.

7. The method according to claim 1, wherein the mode includes an SMV (selective mode vocoder) mode.

8. A method for controlling a mode of a voice signal by using a media gateway provided in a mobile communication system, the media gateway having a vocoder supporting a plurality of modes with regard to the voice signal and conducting a mode conversion of the voice signal, the method comprising the steps of:
i) receiving a mode conversion request message with regard to the voice signal;
ii) determining whether or not it is necessary to convert the mode based on the mode conversion request message; and
iii) transmitting a mode conversion acknowledgement message if the mode conversion is determined.

9. The method according to claim 8, wherein the mode conversion request message or the mode conversion acknowledgement message is transmitted through an A2p-frame with an in-band signaling scheme.

10. The method according to claim 8, wherein the mode conversion request message or the mode conversion acknowledgement message is transmitted through an AMP-frame with an out-of-band signaling scheme.

11. The method according to claim 8, wherein the media gateway includes information related to a time for determining the mode conversion, which is previously determined.

12. The method according to claim 8, wherein, in step i), if it is necessary to covert modes of signals for all subscribers, the media gateway receives a signal requesting the mode conversion from a mobile switching center emulator connected to a base station.

13. The method according to claim 8, wherein step ii) includes a substep of checking an identity of the mode conversion request message.

14. The method according to claim 8, wherein the media gateway checks a message CRC of the mode conversion request message and notifies a base station controller of an error of the mode conversion request message.

15. The method according to claim 1, wherein the mode includes an SMV (selective mode vocoder) mode.

16. An apparatus for controlling a mode of a coded voice signal in a mobile communication system including a media gateway having a transcoder for coding a voice signal with a plurality of modes and converting the voice signal and a base station for receiving/transmitting the coded voice signal, the apparatus comprising:
the base station determining whether or not it is necessary to convert a mode of the voice signal based on a predetermined criterion, and transmitting a mode conversion request message if it is necessary to convert the mode of the voice signal; and
a media gateway receiving the mode conversion request message for the voice signal, determining whether or not it is necessary to convert the mode based on the mode conversion request message, and transmitting a mode conversion acknowledgement message to the base station if the mode conversion is determined.

17. The apparatus according to claim 416, wherein the mode conversion request message or the mode conversion acknowledgement message is transmitted through an A2p-frame with an in-band signaling scheme.

18. The apparatus according to claim 16, wherein the mode conversion request message or the mode conversion acknowledgement message is transmitted through an AMP-frame with an out-of-band signaling scheme.

19. The apparatus according to claim 16, wherein the media gateway includes information related to a time for determining the mode conversion, which is previously determined.

20. The apparatus according to claim 16, wherein, if it is necessary to covert modes of signals for all subscribers, the media gateway receives a signal requesting the mode conversion from a mobile switching center emulator connected to the base station.

21. The apparatus according to claim 16, wherein an identity of the mode conversion request message is checked in order to determine the mode conversion based on the mode conversion request message.

22. The apparatus according to claim 16, wherein the media gateway checks a message CRC of the mode conversion request message and notifies a base station controller of an error of the mode conversion request message.

23. The apparatus according to claim 16, wherein the mode includes an SMV (selective mode vocoder) mode.
